(19) United States
(12) Patent Application Publication
(10) Pub. No.: US 2021/0286851 A1
(43) Pub. Date: Sep. 16, 2021

(54) GUIDED QUERY RECOMMENDATIONS

(71) Applicant: Microsoft Technology Licensing, LLC, Redmond, WA (US)

(72) Inventors: Nagaraj Kota, Bangalore (IN); Venkatesh Duppada, Andhra Pradesh (IN)

(21) Appl. No.: 16/815,581

(22) Filed: Mar. 11, 2020

(51) Int. Cl. G06F 16/9032; G06F 16/9038; G06N 20/00; G06N 5/04

(52) U.S. Cl. CPC G06F 16/90328; G06N 5/04; G06N 20/00; G06F 16/9038

(57) ABSTRACT

Disclosed are systems, methods, and non-transitory computer-readable media for guided query recommendations. A search system generates search query recommendations for a user based on activity data associated with the user. In one technique, the search system generates a search query recommendation based on a search query sequence identified from the activity data of the user. For example, the search query sequence is used as input into a machine learning model, such as a sequence to sequence model trained on historical search query sequences that resulted in a targeted action. In another technique, the search system generates a search query recommendation based on multi-session query data of the user. For example, the search system generates a multi-session embedding vector representing the multiple activity sessions of the user. The multi-session embedding vector is used as input in a classification model that assigns probability values to candidate search terms.

### TECHNICAL FIELD

An embodiment of the invention relates generally to search queries and, more specifically, to guided query recommendations.

### BACKGROUND

Current web services enable users to access a large amount of data. For example, web services that provide job listings allow users to access thousands of available job listings. While these types of web services provide a large amount of available data, finding relevant data can be difficult. To alleviate this issue, many systems provide search functionality that allows users to formulate search queries to identify subsets of the data that are pertinent to the requesting user. For example, these systems may allow a user to generate search queries by entering keywords to define the type of data the user would like to target, such as by entering keywords defining a desired field, title, industry, location, company, etc. While search queries allow a user to target their search for relevant information, in some instances a user may be uncertain on how to formulate a search query to identify relevant data. From a user perspective, this can be frustrating as it may result in a user spending extended periods of times executing various search queries in the hopes of finding relevant information. In some cases, this frustration may lead to the user abandoning use of the service altogether. Accordingly, improvements are needed.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 shows a system for providing guided query recommendations, according to some example embodiments.

FIG. 2 is a block diagram of a search system, according to some example embodiments.

FIG. 3 is a flowchart showing an example method of training a machine learning model that generates search query recommendations based on search query sequences, according to certain example embodiments.

FIG. 4 is a flowchart showing an example method of generating a search query recommendation based on a search query sequence, according to certain example embodiments.

FIG. 5 is a flowchart showing an example method of training a machine learning model for generating search query recommendations based on multi-session activity data, according to certain example embodiments.

FIG. 6 is a flowchart showing an example method of generating a search query recommendation based on multi-session activity data, according to certain example embodiments.

FIG. 7 is a flowchart showing an example method of generating a multi-session embedding vector, according to certain example embodiments.

FIG. 8 shows activity data generated by a search system, accordingly to some example embodiments.

FIG. 9 is a search interface including search query recommendations, according to certain example embodiments.

FIG. 10 is a block diagram illustrating a representative software architecture, which may be used in conjunction with various hardware architectures herein described.

FIG. 11 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

In the following description, for purposes of explanation, various details are set forth in order to provide a thorough understanding of various embodiments of the invention. It will be apparent, however, to one skilled in the art, that the present subject matter may be practiced without these specific details, or with slight alterations.

Reference in the specification to “one embodiment” or “an embodiment” means that a particular feature, structure or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

Disclosed are systems, methods, and non-transitory computer-readable media for guided query recommendations. Current search systems enable users to execute search queries to identify relevant data. For example, search systems often enable users to enter a search term consisting of one or more keywords, which the search system uses to execute a search query for relevant data. Hence, a user searching for Italian restaurants may enter a search term such as “Italian restaurants.” The search system uses the search term (e.g., Italian restaurants) to identify relevant data (e.g., webpages, restaurant listings) that have been tagged with and/or includes the search term or the individual keywords (e.g., Italian, and restaurants), which are then returned to the user as search results.

While using search terms allows users to identify relevant search results, this process is heavily user dependent. For example, users are tasked with selecting the search terms used to execute a search query and adjusting their chosen search term when a search query does not provide relevant search results. In some cases, users may be uncertain as to what modifications to make to find the search results they want. As a result, users may spend extended periods of time trying to different search terms to find relevant search results, which may lead to user frustration and abandonment of the search service altogether.

To alleviate this issue, a search system consistent with some embodiments of the invention is configured to generate search query recommendations for users based on activity data of the user. Activity data includes data describing activities performed by users, such as usage of a search system by users as well as other channel usage such as viewing recommendations, notifications and the like. For example, the activity data may include search terms entered by users, search results returned to users, user actions taken in relation to the search results, such as whether search results were selected by the user, an amount of time the user viewed the resulting content, whether the user took an additional step, such as applying for a job, purchasing an item, making a reservation, or the like. The activity data may further include notifications and/or recommendations presented to a user, whether the user selected a recommendation or notification, performed a desired action, and the like. The search system uses a user's activity data to identify search terms that are likely to result in the user performing a targeted action, such as applying for job, purchasing an item, or the like. For example, the search system determines recommended search terms based on the previous search terms entered by the user and/or actions taken by the user.

The search system may utilize multiple techniques to generate search query recommendations for a user. For example, in one technique the search system generates search query recommendations based on a search query sequence identified from activity data of the user. A search query sequence includes a sequentially ordered list of search terms entered by the user during one or more activity sessions. Accordingly, the search system may analyze activity data of a user to generate a search query sequence from individual search terms entered by the user. The search system uses the search query sequence as input in a machine learning model (e.g., a sequence to sequence model) that is trained to output search query recommendations based on a given input search query.

In another technique, the search system generates search query recommendations based on multi-session activity data describing one or more activity sessions associated with a user. An activity session is a grouped period of activity by a user, such as a continuous period of activity by the user during which the user views notifications, views recommendations and/or uses the search system. For example, an activity session may include a continuous period of activity during which the user uses a client device to view notifications, view recommendations and/or use the functionality of the search system. As another example, an activity session may include user activity that is within a threshold period of time of each other, even if the use is not continuous. For example, a user may have ended their activity for a period of time by logging off, navigating to another site/service, or the like.

In this type of embodiments, the search system may utilize a greater variety of the activity data than in the previous technique that is focused on a search query sequence. For example, the search system may use the search terms entered by the user, the search results, notifications and/or recommendations provided to the user, the search results, notifications and/or recommendations selected by the user, data indicating whether the user performed additional actions, such as applying for a job, purchasing an item, etc. In this type of embodiment, the search system generates a single multi-session embedding vector representing multiple activity sessions associated with the user.

The search system generates the multi-session embedding vector based on single session embedding vectors representing each of the individual activity sessions represented by the multi-session embedding vector. For example, the search system uses a word embedding encoder to generate token embedding vectors representing each token in the activity sessions. The search system then generates a single session embedding vector for an activity session based on the set of token embedding vectors generated for tokens included in the activity session. For example, the single session embedding vector representing an activity session may be an average of the set of token embedding vectors generated for tokens included in the activity session. Alternatively, the single session embedding vector may be determined from set of token embedding vectors using another method or calculation.

The search system uses the single session embedding vectors for each individual activity session to generate a multi-session embedding vector that represents the multiple activity sessions. For example, the multi-session embedding vector may be the average, dot product, or the like, of the single session embedding vectors representing each of the individual activity sessions.

The search system generates search query recommendations based on the multi-session embedding vectors. For example, the search system uses the multi-session embedding vectors as input in a machine learning model, such as a classification model, that is trained to generate probability values for a set of classification labels based on an input multi-session embedding vector. Each classification label may represent a candidate search term that may be provided as a search query recommendation. For example, each classification label may be associated with an individual keyword or multiple keywords that represent the candidate search term. The probability values determined for each classification label indicate the likelihood that the corresponding search term will provide the user with relevant data, such as by providing the user with search result that will cause the user to perform a targeted action. For example, the targeted action may be clicking on the search result, purchasing an item, applying for a job, viewing content for at least a threshold amount of time, or the like.

The search system uses the probability values to generate a search query recommendation for the user. For example, the search system may use the search term corresponding to the classification label with the highest probability value as a search query recommendation or provide multiple search query recommendations based on the search terms associated with multiple classification labels with the highest probability values (e.g., top 5). The search system may present the search query recommendation to the user, such as by presenting the search term to the user in a user interface. Other aspects of the various embodiments of the invention will be readily apparent from the description of the figures that follows.

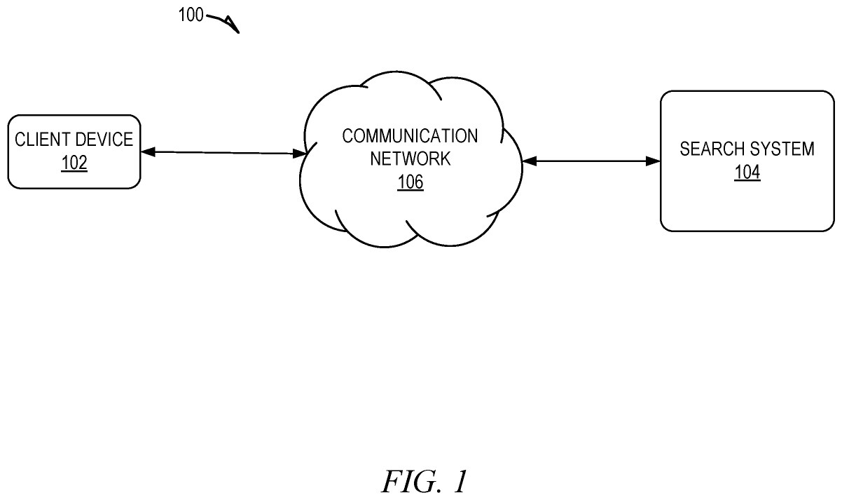

FIG. 1 shows a system for providing guided query recommendations, according to some example embodiments. As shown, multiple devices (i.e., a client device 102 and a search system 104) are connected to a communication network 104 and configured to communicate with each other through use of the communication network 104. The communication network 104 is any type of network, including a local area network (“LAN”), such as an intranet, a wide area network (“WAN”), such as the Internet, or any combination thereof. Further, the communication network 104 may be a public network, a private network, or a combination thereof. The communication network 104 is implemented using any number of communication links associated with one or more service providers, including one or more wired communication links, one or more wireless communication links, or any combination thereof. Additionally, the communication network 104 is configured to support the transmission of data formatted using any number of protocols.

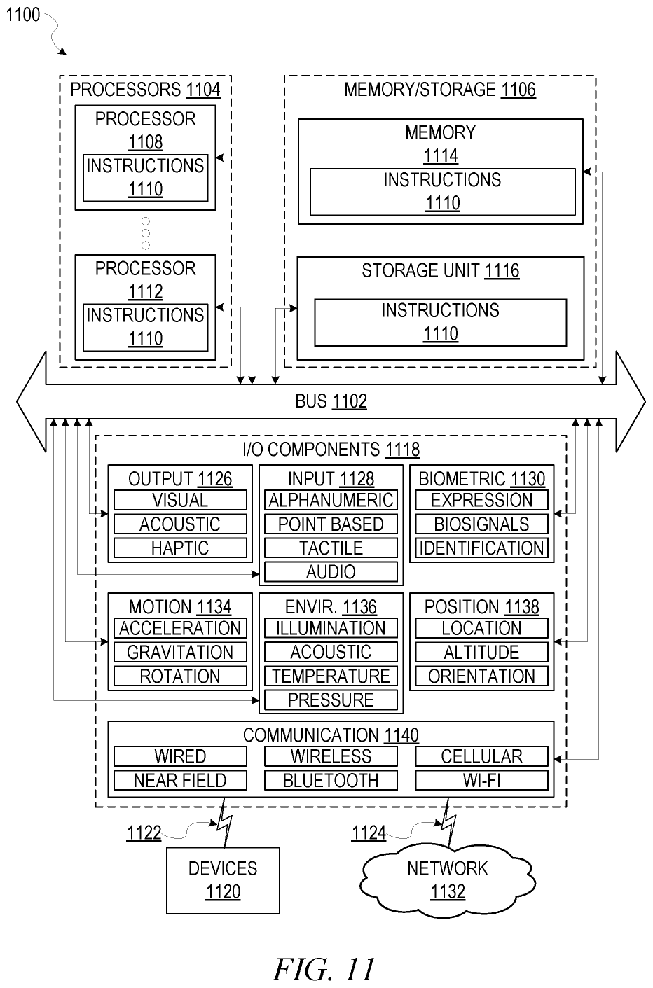

Multiple computing devices can be connected to the communication network 104. A computing device is any type of general computing device capable of network communication with other computing devices. For example, a computing device can be a personal computing device such as a desktop or workstation, a business server, or a portable computing device, such as a laptop, smart phone, or a tablet Personal Computer (PC). A computing device can include some or all of the features, components, and peripherals of the machine 1100 shown in FIG. 11.

To facilitate communication with other computing devices, a computing device includes a communication interface configured to receive a communication, such as a request, data, etc., from another computing device in network communication with the computing device and pass the communication along to an appropriate processing module executing on the computing device. The communication interface also sends a communication (e.g., transmits data) to other computing devices in network communication with the computing device.

In the system 100, users interact with the search system 104 to execute search queries for data. For example, a user uses the client device 102 connected to the communication network 106 by direct and/or indirect communication to communicate with and utilize the functionality of the search system 104. Although the shown system 100 includes only one client device 102, this is only for ease of explanation and is not meant to be limiting. One skilled in the art would appreciate that the system 100 can include any number of client devices 102. Further, the search system 104 may concurrently accept connections from and interact with any number of client devices 102. The search system 104 supports connections from a variety of different types of client devices 102, such as desktop computers; mobile computers; mobile communication devices, e.g. mobile phones, smart phones, tablets; smart televisions; set-top boxes; and/or any other network-enabled computing devices. Hence, the client device 102 may be of varying type, capabilities, operating systems, etc.

A user interacts with the search system 104 via a client-side application installed on and executing at the client device 102. In some embodiments, the client-side application includes a search system specific component. For example, the component may be a stand-alone application, one or more application plug-ins, and/or a browser extension. However, the users may also interact with the search system 104 via a third-party application, such as a web browser, that resides on the client device 102 and is configured to communicate with the search system 104. In either case, the client-side application presents a user interface (UI) for the user to interact with the search system 104. For example, the user interacts with the search system 104 via a client-side application integrated with the file system or via a webpage displayed using a web browser application.

The search system 104 comprises one or more computing devices configured to execute user specified search queries for data and provide any resulting search results to the user. The search system 104 can be a standalone system or integrated into other systems or services, such as being integrated into a website, web service, etc. For example, the search system 104 may be integrated into a professional social networking service and used to facilitate search queries for job postings maintained by the professional social networking service. In either case, the search system 104 facilitates search queries for data, where a user using a client device 102 can enter search parameters for the search query and receive any resulting search results.

The search system 104 enables a user to execute a search query for data maintained by the search system 104 and/or data maintained by other data sources (not shown) in network communication with the search system 104. For example, the search system 104 provides the user with a search interface that enables the user to provide a search term used to execute a search query. A search term comprises one or more keywords provided by the user to identify the type of data the user that is relevant to the user. For example, a user searching for relevant job openings may include search terms identifying their desired field, title, level, location, company, and the like.

In response to receiving a search term from a client device 102, the search system 104 executes a search query based on the search term. For example, the search system 104 searches data in a data storage maintained by the search system 104 and/or web service in which the search system 104 is integrated. The search system 104 may also search data stored by other data sources. The search system 104 provides any resulting search results to the client device 102, where they are presented to the requesting user.

As explained earlier, current search systems are heavily user dependent. For example, users are tasked with selecting the search terms used to execute a search query and adjusting the search term when a search query does not provide relevant search results. In some cases, users may be uncertain as to what modifications to make to find the search results they want. As a result, users may spend extended periods of time trying to different search terms to find relevant search results, which may lead to user frustration and abandonment of the search service altogether.

To alleviate these existing issues, the search system 104 generates search query recommendations for users based on activity data. Activity data includes data describing activities performed by users, such as usage of a search system 104 by users as well as other channel usage such as viewing recommendations, notifications and the like. For example, the activity data may include search terms entered by users, search results returned to users, user actions taken in relation to the search results, such as whether search results were selected by the user, an amount of time the user viewed the resulting content, whether the user took an additional step, such as applying for a job, purchasing an item, making a reservation, or the like. The activity data may further include notifications and/or recommendations presented to a user, whether the user selected a recommendation or notification, performed a desired action, and the like. The search system 104 uses a user's activity data to identify search terms that are likely to result in the user performing a targeted action, such as applying for a listed job. For example, the search system 104 determines recommended search terms based on the previous search terms entered by the user and/or actions taken by the user.

The search system 104 may utilize multiple techniques to generate search query recommendations for a user. For example, in one technique the search system 104 generates search query recommendations based on a search query sequence identified from activity data of the user. A search query sequence includes a sequentially ordered list of search terms entered by the user during one or more activity sessions. Accordingly, the search system 104 may analyze activity data of a user to generate a search query sequence from individual search terms entered by the user. The search system 104 uses the search query sequence as input in a machine learning model that is trained to output search query recommendations based on a given input search query.

In another technique, the search system 104 generates search query recommendations based on multi-session activity data describing one or more activity sessions associated with a user. In this type of embodiment, the search system 104 may utilize a greater variety of the activity data than just the search terms entered by the user, as in the first technique. For example, the search system 104 may use the search terms entered by the user, the search results, notifications and/or recommendations provided to the user, the search results selected by the user, data indicating whether the user performed additional actions, such as applying for a job, purchasing an item, etc. In this type of embodiment, the search system 104 generates a single multi-session embedding vector representing multiple activity sessions associated with the user.

The search system 104 generates the multi-session embedding vector based on single session embedding vectors representing each of the individual activity sessions represented by the multi-session embedding vector. For example, the search system 104 uses a machine learning model, such as a word embedding encoder, to generate token embedding vectors representing each token in the activity sessions. The search system 104 then generates a single session embedding vector for an activity session based on the set of token embedding vectors generated for tokens included in the activity session. For example, the single session embedding vector representing an activity session may be an average of the set of token embedding vectors generated for tokens included in the activity session.

The search system 104 uses the single session embedding vectors for each individual activity session to generate a multi-session embedding vector that represents the multiple activity session. For example, the multi-session embedding vector may be an average of the single session embedding vectors representing each of the individual activity sessions.

The search system 104 generates search query recommendations based on the multi-session embedding vectors. For example, the search system 104 uses the multi-session embedding vectors as input in a classification model that is trained to generate probability values for a set of classification labels based on an input multi-session embedding vector. Each classification label may represent a candidate search term that may be provided as a search query recommendation. For example, each classification label may be associated with an individual keyword or multiple keywords that represent the candidate search term. The probability values determined for each classification label indicate the likelihood that the corresponding search term will provide the user with relevant data, such as by providing the user with search results that will cause the user to perform a targeted action. For example, the targeted action may be clicking on the search result, purchasing an item, applying for a job, viewing content for at least a threshold amount of time, or the like.

The search system 104 uses the probability values to generate search query recommendations for the user. For example, the search system 104 may use the search terms corresponding to one or more of the classification labels with the highest probability values as search query recommendations. The search system may present the search query recommendation to the user, such as by presenting the search term to the user in a user interface. Other aspects of the various embodiments of the invention will be readily apparent from the description of the figures that follows.

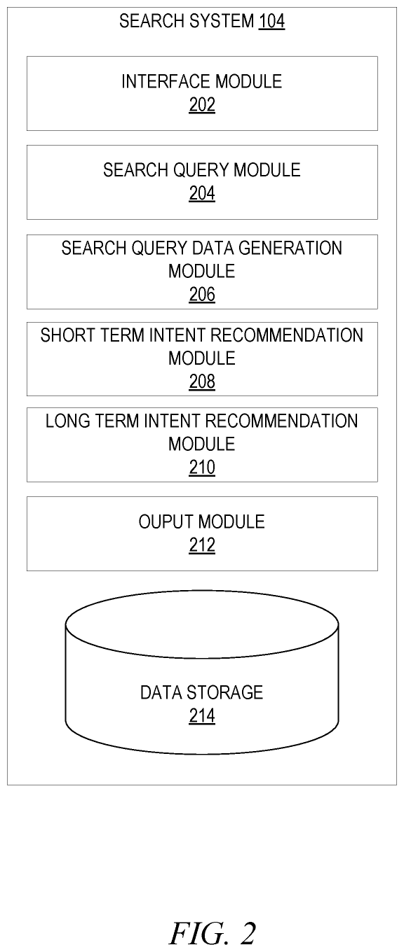

FIG. 2. is a block diagram of a search system 104, according to some example embodiments. To avoid obscuring the inventive subject matter with unnecessary detail, various functional components (e.g., modules) that are not germane to conveying an understanding of the inventive subject matter have been omitted from FIG. 2. However, a skilled artisan will readily recognize that various additional functional components may be supported by the search system 104 to facilitate additional functionality that is not specifically described herein. Furthermore, the various functional modules depicted in FIG. 2 may reside on a single computing device or may be distributed across several computing devices in various arrangements such as those used in cloud-based architectures.

As shown, the search system 104 includes an interface module 202, a search query module 204, an activity data generation module 206, a short-term intent recommendation module 208, a long-term intent recommendation module 210, an output module 212, and a data storage 214.

The interface module 202 provides a search interface that enables the user to execute a search query for data as well as review the corresponding search results. For example, the interface module 202 provides data to a client device 102, which the client device 102 uses to present the search interface on a display of the client device 102. Similarly, the interface module 202 receives data from a client device 102 to provide the functionality of the search interface.

The search interface includes user interface elements, such as buttons, text, text boxes, drop down boxes, etc., that enable a user to enter search terms and execute a search query. The search terms may consist of one or more keywords entered by a user to identify the type of data that the user is interested in finding. The search interface presents the user with any resulting search results. For example, the search interface lists the search results and enables the user to select, click, etc., the search results to access secondary information associated with the search result. For example, the search results include the titles of jobs identified as a result of the user's provided search term. The user may select one of the search results to access additional details about a selected job listing.

The search query module 204 executes a search query based on the search terms provided by the user. For example, the search query module 204 executes a search in one or more data stores for data that includes and/or is tagged with the search term and/or the individual keywords included in the search term. For example, the search query module 204 may execute a search query of a data store that includes data describing restaurants by identifying data that includes and/or is tagged with the search term provided by the user. As another example, the search query module 204 may execute a search query of a data store that includes data describing job listings for data that includes and/or is tagged with the search term provided by the user.

The search query module 204 may execute the search query in the data storage 214 maintained by the search system 104 or a service in which the search system is implemented (e.g., a professional social networking service). Alternatively, the search query module 204 may execute the search query in data stores maintained by web servers, web services, etc., that are in network connection with the search query module 204. The search query module 204 returns any search results of the search query.

The activity data generation module 206 generates activity data describing use of the search system 104. For example, the activity data may include recorded data describing executed search queries and resulting actions performed by users. That is, the activity data may include search terms entered by users, search results provided in response to the search queries, user interactions in relation to the search results (e.g., user selections, performance of an additional action), and the like. The activity data may also include additional metadata describing the recorded search queries. For example, the activity data may include a unique identifier identifying a user and/or user account associated with the recorded activity data. The activity data may also include timestamps indicating a time at which a search query was executed, times at which search results were selected, times at which additional actions were performed, and the like. The activity data may further include notifications and/or recommendations presented to a user, whether the user selected a recommendation or notification, performed a desired action, and the like.

The activity data generation module 206 may generate a separate data record for each activity session of a user. That is, each data record would include activity data related to a single activity session of a user. An activity session is a grouped period of activity by a user, such as a continuous period of activity by the user during which the user views notifications, views recommendations and/or uses the search system. For example, an activity session may include a continuous period of activity during which the user uses a client device to view notifications, view recommendations and/or use the functionality of the search system 104. As another example, an activity session may include activity that is within a threshold period of time of each other, even if the use is not continuous. For example, a user may have ended their activity for a period of time by logging off, navigating to another site/service, or the like.

The activity data generation module 206 stores the activity data it generates in the data storage 214, where it accessible to the other modules of the search system 104.

The short-term intent recommendation module 206 generates recommended search queries based on a search query sequence of a user. A search query sequence is a sequentially ordered list of search terms entered by the user that is determined to be related and/or part of a continuous sequence of search queries. For example, the search query sequence may include a sequence of search terms that were entered within a specified time period, a sequence of search terms that were each entered within a specified time period of the previously and/or subsequently entered search term, a sequence of search terms that are determined to be modifications of a previously entered search term, and the like. A user's search query sequence can represent a short-term intent of the user in that it represent the user's current (e.g., short-term) intent regarding use of the search system 104, such as the type of data the user is currently intending to find through use of the search system 104.

To generate a recommended search query, the short-term intent recommendation module 206 uses a user's search query sequence as input in a machine learning model, such as a recurrent neural network (RNN) based encoder-decoder model, that is trained to output search query recommendations based on a given input search query. For example, the machine learning model may be a sequence to sequence model that maps a fixed-length input with a fixed-length output where the length of the input and output may differ. These types of machine learning models include an encoder that learns a representation for a provided input sequence and a decoder that uses the representation for the provided input to generate an output sequence. Examples of sequence to sequence machine learning models include seq2seq, seq2sequ using Long short-term memory (LSTM) or GRU cells, seq2seq with attention, transformer, and the like.

In any case, the machine learning model receives a search query sequence as an input sequence, and outputs a search term consisting of one or more keywords based on the provided input sequence. The search term output by the machine learning model represents a search term that is likely to result in user performance of a targeted action, such as purchasing an item, applying for a job, making a reservation at a restaurant, etc.

The short-term intent recommendation module 206 generates the machine learning model based on a set of training search query sequences that are identified from historical activity data. For example, the short-term intent recommendation module 206 gathers historical activity data stored in the data storage 214 that describes previous use of the search system 104 (e.g., search terms, search results, actions performed, and the like).

The short-term intent recommendation module 206 identifies successful search queries in the activity data that resulted in user performance of a targeted action. For example, the short-term intent recommendation module 206 may identify search queries that resulted in a user successfully performing a targeted action in relation to one or more of the search results resulting from the search query, such as applying to a job listing that was provided as a search result.

The short-term intent recommendation module 206 generates the set of training search query sequences based on the successful search queries identified in the activity data. For example, each training search query may be a search query sequence that led to one of the successful search queries identified from the activity data. Accordingly, the short-term intent recommendation module 206 analyzes the activity data to identify the search query sequence that resulted in the successful search query. For example, the short-term intent recommendation module 206 may identify previous search queries that were executed within a specified time period of the successful search query, previous search query that were executed within a predetermined time of a subsequent and/or previous search query, each previous search query that was a reformulation of a previous search query, and the like.

The short-term intent recommendation module 206 uses the generated set of training search query sequences to train the machine learning model. In some embodiments, the short-term intent recommendation module 206 may train the machine learning model based on additional data as well. For example, the short-term intent recommendation module 206 may generate the machine learning model using additional contextual data, such as data describing an industry associated with the search query sequence, or the like.

Training a machine learning model based on search query sequences that led to successful search queries (e.g., search queries that resulted in a targeted action) produces a machine learning model that generates recommended search queries that are also likely to successfully result in the targeted action. This contrasts with previous uses of sequence to sequence based machine learning model in which the machine learning model simply outputs the next likely sequence given an input sequence, without consideration as to whether the next sequence will be successful in achieving the targeted action. By generating a machine learning model that outputs search query recommendations that are likely to result in a targeted action representing an end goal of a user, such as applying to a job, making a restaurant reservation, and the like, the search system 104 reduces the number of search queries that a user executes to achieve their goal. As a result, computing resource usage is reduced and perceived performance of the computing systems is increased, thereby provided a technical improvement to the functioning of prior systems.

To generate a search query recommendation for a user, the short-term intent recommendation module 206 generates an input for the machine learning model, which includes the search query sequence of the user as well as an additional contextual data, such as data describing an industry associated with the search query sequence, or the like, that was used to train the machine learning model.

To generate the search query sequence, the short-term intent recommendation module 206 accesses activity data associated with the user and identifies a search query sequence of the user. The search query sequence may be a most recent search query sequence associate with the use. For example, the short-term intent recommendation module 206 may identify a most recent search query executed by the user and identify the search query sequence that led to the most recent search query. For example, the short-term intent recommendation module 206 may identify previous search queries that were executed within a specified time period of the most recent search query, previous search query that were executed within a predetermined time of a subsequent and/or previous search query, search queries that are a reformulation of a previous search query, and the like.

The short-term intent recommendation module 206 uses the generated input (e.g., search query sequence and additional contextual data) as input into the machine learning model. In turn, the machine learning model outputs a search term (e.g., one or more keyword) that is likely to result in the target action. The short-term intent recommendation module 206 generates a search query recommendation based on the search term provided as output by the machine learning model.

The long-term intent recommendation module 208 generates recommended search queries based on multi-session activity data of a user. Multi-session activity data of a user describes activity by the user over multiple activity sessions. An activity session is a grouped period of activity by a user. For example, an activity session may be a continuous use of the search system 104 and/or viewing notifications/recommendations by a user, such as a continuous period during which the user uses a client device 102 to access and utilize the functionality of the search system 104. As another example, an activity session may activity by the user that is within a threshold period of time of each other, even if the use is not continuous. For example, a user may have ended their activity by logging off, navigating to another site/service, or the like. The multi-session activity data of the user may represent a long-term intent of the user in that it represents the user's intended use of the search system 104 for a longer period of time that spans multiple activity session.

The multi-session activity data may include a greater variety of the activity data than used by short-term intent recommendation module 206 to generated search query recommendations. For example, the multi-session activity data may include each of search terms entered by the user, the search results, recommendations and/or notifications provided to the user, the search results, recommendations and/or notifications selected by the user, data indicating whether the user performed additional actions, and the like, during the activity sessions.

To generate a search query recommendation based on multi-session activity data, the search system generates a multi-session embedding vector based on multi-session activity data. The resulting multi-session embedding vector represents the multiple activity sessions described by the multi-session query data. The number of activity sessions used to generate the multi-session embedding vector may vary based on the desired length of intent that is desired to be captured. For example, a higher number of activity sessions may be used to generate a multi-session embedding vector representing a longer intent of the user, whereas a lower number or even a single activity session may be used to generate a multi-session embedding vector representing a relatively shorter intent of the user.

The long-term intent recommendation module 208 generates a multi-session embedding vector based on a set of single session embedding vectors that represent each individual activity session from the multiple activity session to be represented by the multi-session embedding vector. Similarly, the long-term intent recommendation module 208 generates each single session embedding vector based on a set of token embedding vectors representing each individual token in the activity data describing the activity session.

The long-term intent recommendation module 208 generates each token embedding vector using a machine learning encoder trained based on historical activity data. The machine learning encoder may be any suitable type of machine learning encoder, such as a Bidirectional Encoder Representations from Transformer (BERT) encoded, or the like. The long-term intent recommendation module 208 accesses activity data sets corresponding to each activity session of the user and uses the tokens within each activity data set as input in the machine learning encoder.

The long-term intent recommendation module 208 uses the resulting token embedding vectors corresponding to each activity session (e.g., the token embedding vectors generated from tokens within a single activity data set) to generate the single session embedding vector representing the activity session. For example, the single session embedding vector may be an average vector based on the set of token embedding vectors. The long-term intent recommendation module 208 similarly generates the multi-session embedding vector based on the resulting set of single session embedding vector. For example, the multi-session embedding vector may be an average vector based on the set of single session embedding vectors.

The long-term intent recommendation module 208 uses the multi-session embedding vector as input to a classification model that generates probability values for a set of candidate search terms. Any type of classification model may be used, such as a classification model that ranks the candidate search query terms using extreme classification (ex. Slice) techniques. The long-term intent recommendation module 208 trains the classification model based on the training multi-session embedding vectors generated from historical activity data, as well as the historical activity data itself. The resulting classification model generates probability values indicating the likelihood that each candidate search term will be used by the user and/or will be successful in achieving a targeted action given an input multi-session embedding vector. Accordingly, the long-term intent recommendation module 208 uses the resulting probability values to select the candidate search terms that have the highest likelihood of being used by the user and/or will be successful in achieving a targeted action based on the user's previous search query history. The long-term intent recommendation module 208 may then generate a search query recommendation based on the selected candidate search terms.

In some embodiments, the long-term intent recommendation module 208 may use a multi-session embedding vector to identify a subset of the candidate search terms that are most likely relevant to the particular user. For example, the long-term intent recommendation module 208 may use a classification model that ranks the candidate search query terms using extreme classification (ex. Slice) techniques to identify a subset of the candidate search terms. The classification model may generate probability values for this identified subset of candidate search terms, rather than the complete pool of candidate search terms, thereby reducing the number of calculations performed when generating the probability values. As a result, the perceived speed of the computing device is increased.

The search system 104 may generate search query recommendations for a user using either the short-term intent recommendation module 208 and/or the long-term intent recommendation module 210. For example, the search system 104 may use the short-term intent recommendation module 208 when a user has not yet engaged in multiple activity sessions.

The output module 212 causes presentation of a search query recommendation to a user. For example, the output module 212 may cause the search query recommendation to be presented within a search interface presented on a display of a client device 102 of the user. The search query recommendation may include text identifying the search terms on the search query recommendation, which the user may then enter to execute a search query. As another example, the search query recommendation presented to the user may be selectable to cause execution of a search query based on the search terms.

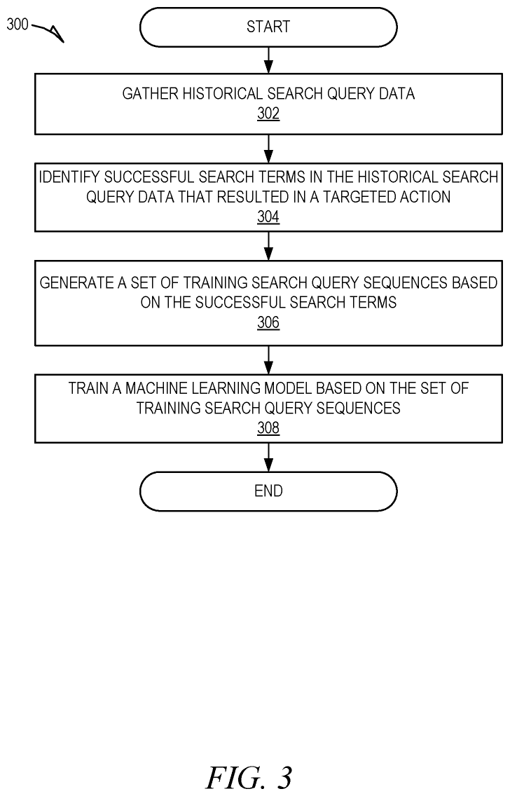

FIG. 3 is a flowchart showing an example method of training a machine learning model for generating search query recommendations based on search query sequences, according to certain example embodiments. The method 300 may be embodied in computer readable instructions for execution by one or more processors such that the operations of the method 300 may be performed in part or in whole by the search system 104; accordingly, the method 300 is described below by way of example with reference thereto. However, it shall be appreciated that at least some of the operations of the method 300 may be deployed on various other hardware configurations and the method 300 is not intended to be limited to the search system 104.

At operation 302, the short-term intent recommendation module 208 gathers historical activity data. For example, the short-term intent recommendation module 206 gathers historical activity data stored in the data storage 214 that describes previous activity of the user, such as use of the search system 104 (e.g., search terms, search results, actions performed, and the like), as well as other channels such as notification and/or recommendations.

At operation 304, the short-term intent recommendation module 208 identifies search terms in the historical activity data that resulted in a targeted action. For example, the short-term intent recommendation module 206 may identify search queries that resulted in a user successfully performing a targeted action in relation to one or more of the search results resulting from the search query, such as applying to a job listing that was provided as a search result.

At operation 306, the short-term intent recommendation module 208 generates a set of training search query sequences based on the successful search terms. For example, each training search query may be a search query sequence that led to one of the successful search queries identified from the activity data. Accordingly, the short-term intent recommendation module 206 analyzed the activity data to identify the search query sequence that resulted in the successful search query. For example, the short-term intent recommendation module 206 may identify previous search queries that were executed within a specified time period of the successful search query, previous search query that were executed within a predetermined time of a subsequent and/or previous search query, each previous search query that was a reformulation of a previous search query, and the like.

At operation 308, the short-term intent recommendation module 208 trains a machine learning model based on the set of training search query sequences. For example, the machine learning model may be a sequence to sequence model that maps a fixed-length input with a fixed-length output where the length of the input and output may differ. These types of machine learning models include an encoder that learns a representation for a provided input sequence that the decoder uses to generate an output sequence. Examples of sequence to sequence machine learning models include seq2seq, seq2sequ using Long short-term memory (LS™) or GRU cells, seq2seq with attention, Transformer, and the like.

In some embodiments, the short-term intent recommendation module 206 may train the machine learning model based on additional data as well. For example, the short-term intent recommendation module 206 may generate the machine learning model using additional contextual data, such as data describing an industry associated with the search query sequence, or the like.

Training a machine learning model based on search query sequences that led to successful search queries (e.g., search queries that resulted in a targeted action) produces a machine learning model that generates recommended search queries that are also likely to successfully result in the targeted action. This contrasts with previous uses of sequence to sequence based machine learning model in which the machine learning model simply outputs the next likely sequence given an input sequence, without consideration as to whether the next sequence will be successful in achieving the targeted action. By generating a machine learning model that outputs search query recommendations that are likely to result in a targeted action representing an end goal of a user, such as applying to a job, making a restaurant reservation, and the like, the search system 104 reduces the number of search queries that a user executes to achieve their goal. As a result, computing resource usage is reduced and perceived performance of the computing systems is increased, thereby provided a technical improvement to the functioning of prior systems.

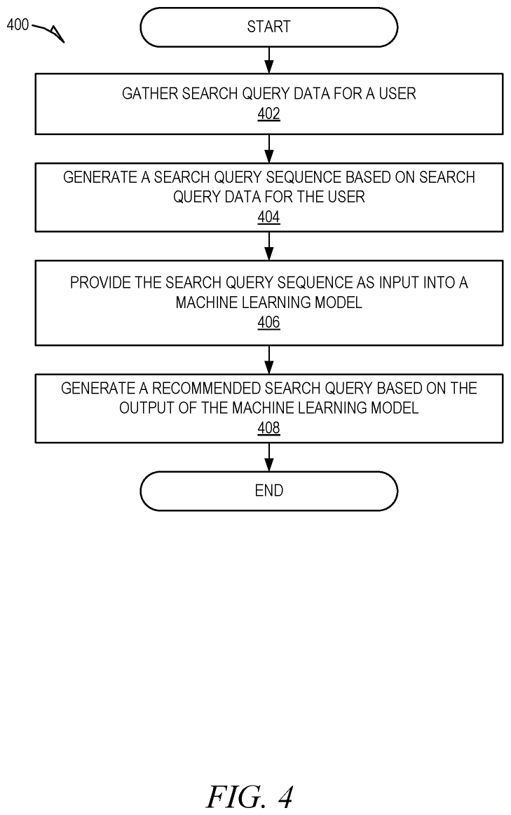

FIG. 4 is a flowchart showing an example method of generating a search query recommendation based on a search query sequence, according to certain example embodiments. The method 400 may be embodied in computer readable instructions for execution by one or more processors such that the operations of the method 400 may be performed in part or in whole by the search system 104; accordingly, the method 400 is described below by way of example with reference thereto. However, it shall be appreciated that at least some of the operations of the method 400 may be deployed on various other hardware configurations and the method 400 is not intended to be limited to the search system 104.

At operation 402, the short-term intent recommendation module 208 gathers activity data for a user. For example, the short-term intent recommendation module 208 may gather the activity data for the user from the data storage 214.

At operation 404 the short-term intent recommendation module 208 generates a search query sequence based on the activity data for the user. To generate the search query sequence, the short-term intent recommendation module 206 accesses activity data associated with the user and identifies a search query sequence of the user. The search query sequence may be a most recent search query sequence associate with the use. For example, the short-term intent recommendation module 206 may identify a most recent search query executed by the user and identify the search query sequence that led to the most recent search query. For example, the short-term intent recommendation module 206 may identify previous search queries that were executed within a specified time period of the most recent search query, previous search query that were executed within a predetermined time of a subsequent and/or previous search query, search queries that are a reformulation of a previous search query, and the like.

At operation 406, the short-term intent recommendation module 208 provides the search query sequence as input into a machine learning model. In some embodiments, the short-term intent recommendation module 208 may also provide additional contextual data as input into the machine learning model. The machine learning model may be an RNN based encoder-decoder model that is trained to output search query recommendations based on a given input search query. Accordingly, the machine learning model outputs a search term (e.g., one or more keyword) based on the provided input.

At operation 408, the short-term intent recommendation module 208 generates a recommended search query based on an output of the machine learning model. For example, the recommended search query may include the search terms output by the machine learning model.

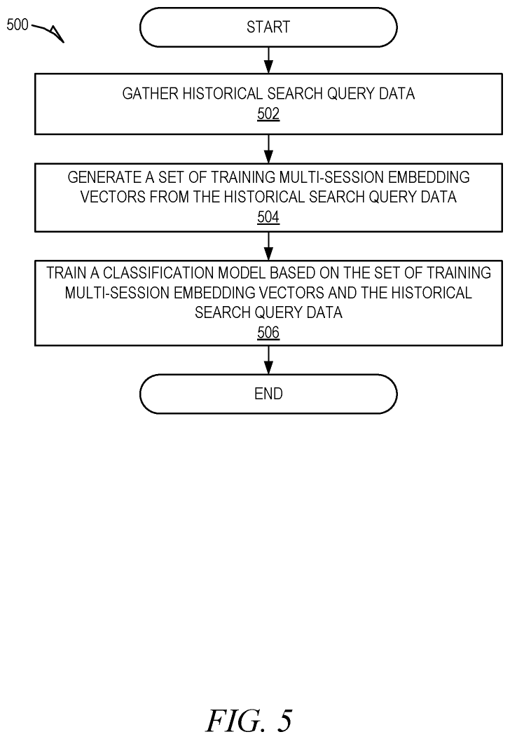

FIG. 5 is a flowchart showing an example method of training a statistical model for generating search query recommendations based on multi-session activity data, according to certain example embodiments. The method 500 may be embodied in computer readable instructions for execution by one or more processors such that the operations of the method 500 may be performed in part or in whole by the search system 104; accordingly, the method 500 is described below by way of example with reference thereto. However, it shall be appreciated that at least some of the operations of the method 500 may be deployed on various other hardware configurations and the method 500 is not intended to be limited to the search system 104.

At operation 502, the long-term intent recommendation module 208 gathers historical activity data. For example, the long-term intent recommendation module 208 gathers historical activity data stored in the data storage 214 that describes previous user activity, such as use of the search system 104 (e.g., search terms, search results, actions performed, and the like) and other channels (e.g., recommendations and notifications).

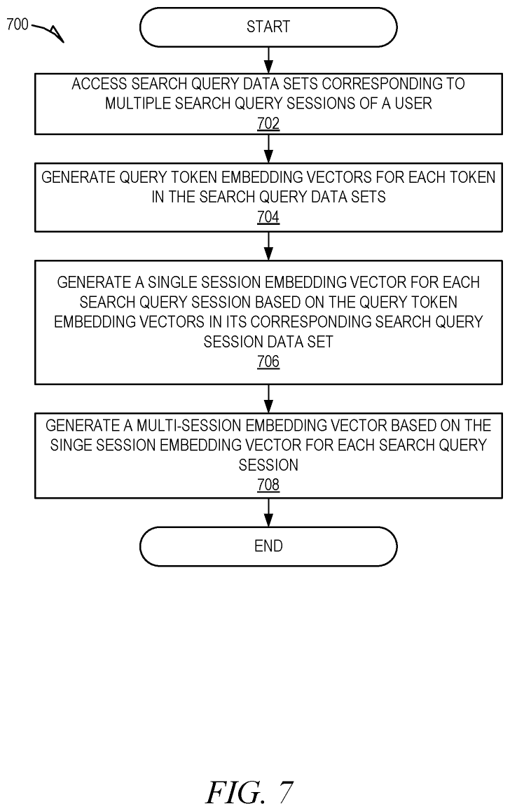

At operation 504, the long-term intent recommendation module 208 generates a set of training multi-session embedding vectors from the historical activity data 504. Each training multi-session embedding vector represents multiple activity sessions of a user. The long-term intent recommendation module 208 generates each training multi-session embedding vector based on a set of single session embedding vectors that represent individual activity sessions included in the multiple activity sessions. Similarly, the long-term intent recommendation module 208 generates each single session embedding vector based on a set of token embedding vectors representing each individual token in the activity data describing the activity session. The long-term intent recommendation module 208 may generate a multi-session embedding vector using the method 700 described below in relation to FIG. 7.

At operation 506, the long-term intent recommendation module 208 trains a classification model based on the set of training multi-session embedding vectors and the historical activity data. The resulting classification model generates probability values indicating the likelihood that each candidate search term will be used by the user and/or will be successful in achieving a targeted action given an input multi-session embedding vector.

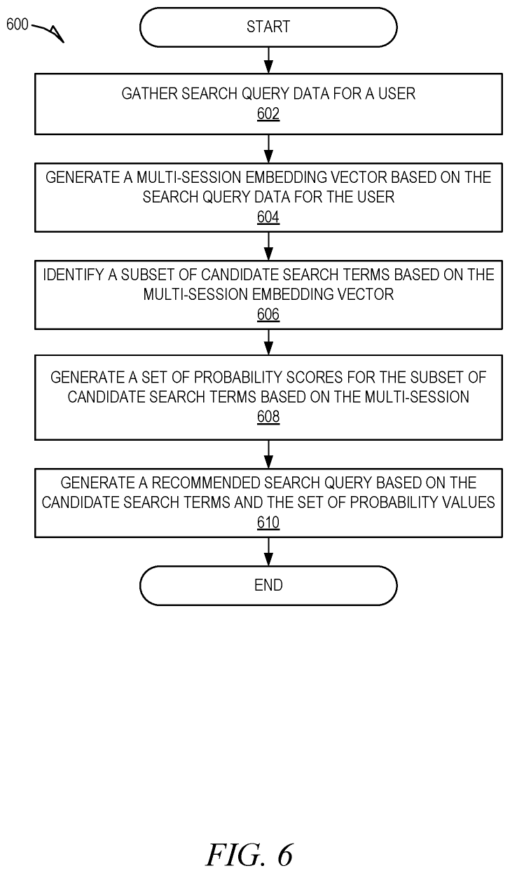

FIG. 6 is a flowchart showing an example method of generating a search query recommendation based on multi-session activity data, according to certain example embodiments. The method 600 may be embodied in computer readable instructions for execution by one or more processors such that the operations of the method 600 may be performed in part or in whole by the search system 104; accordingly, the method 600 is described below by way of example with reference thereto. However, it shall be appreciated that at least some of the operations of the method 600 may be deployed on various other hardware configurations and the method 600 is not intended to be limited to the search system 104.

At operation 602, the long-term intent recommendation module 208 gathers activity data for a user. For example, the long-term intent recommendation module 208 may gather the activity data for the user from the data storage 214.

At operation 604, the long-term intent recommendation module 208 generates a multi-session embedding vector based on the activity data for the user. The multi-session embedding vector represents multiple activity sessions described by the multi-session query data. The long-term intent recommendation module 208 may generate a multi-session embedding vector using the method 700 described below in relation to FIG. 7.

At operation 606, the long-term intent recommendation module 208 identifies a subset of candidate search terms based on the multi-session embedding vector. For example, the long-term intent recommendation module 208 may use a classification model that ranks the candidate search query terms using extreme classification (ex. Slice) techniques to identify a subset of the candidate search terms. The classification model may generate probability values for this identified subset of candidate search terms, rather than the complete pool of candidate search terms, thereby reducing the number of calculations performed when generating the probability values. As a result, the perceived speed of the computing device is increased.

At operation 608, the long-term intent recommendation module 208 generates a set of probability values for the subset of candidate search terms based on the multi-session embedding vector. For example, the long-term intent recommendation module 208 uses the multi-session embedding vector as input to a classification model that generates probability values for the subset of candidate search terms.

At operation 610, the long-term intent recommendation module 208 generates a recommended search query based on the candidate search terms and the set of probability values. The long-term intent recommendation module 208 uses the resulting probability values to select the candidate search terms that have the highest likelihood of being used by the user and/or will be successful in achieving a targeted action based on the user's previous search query history. The long-term intent recommendation module 208 may then generate a search query recommendation based on the selected candidate search terms.

FIG. 7 is a flowchart showing an example method of generating a multi-session embedding vector, according to certain example embodiments. The method 700 may be embodied in computer readable instructions for execution by one or more processors such that the operations of the method 700 may be performed in part or in whole by the search system 104; accordingly, the method 700 is described below by way of example with reference thereto. However, it shall be appreciated that at least some of the operations of the method 700 may be deployed on various other hardware configurations and the method 700 is not intended to be limited to the search system 104.

At operation 702, the long-term intent recommendation module 210 accesses activity data sets corresponding to multiple activity sessions of a user. An activity session is a grouped period of activity by a user. For example, an activity session may be a continuous period of activity during which the user views notifications, views recommendations and/or uses a client device to access and utilize the functionality of the search system 104. Each activity data set includes activity data describing one of the multiple activity sessions of the user. The long-term intent recommendation module 210 accesses the activity data sets from the data storage 214.

At operation 704, the long-term intent recommendation module 210 generates query token embedding vectors for each token in the activity data sets. The long-term intent recommendation module 208 generates each token embedding vector using a machine learning encoder trained based on historical activity data. The machine learning encoder may be any suitable type of machine learning encoder, such as a Bidirectional Encoder Representations from Transformer (BERT) encoded, or the like. The long-term intent recommendation module 208 accesses activity data sets corresponding to each activity session of the user and uses the tokens within each activity data set as input in the machine learning encoder.

At operation 706, the long-term intent recommendation module 210, generates a single session embedding vector for each activity session. For example, the long-term intent recommendation module 208 uses the resulting token embedding vectors corresponding to each activity session (e.g., the token embedding vectors generated from tokens within a single activity data set) to generate the single session embedding vector representing the activity session. In some embodiments, the single session embedding vector may be an average vector based on the set of token embedding vectors.

At operation 708, the long-term intent recommendation module 210 generates a multi-session embedding vector based on the single session embedding vectors for each activity session. The long-term intent recommendation module 208 similarly generates the multi-session embedding vector based on the resulting set of single session embedding vector. For example, the multi-session embedding vector may be an average vector based on the set of single session embedding vectors.

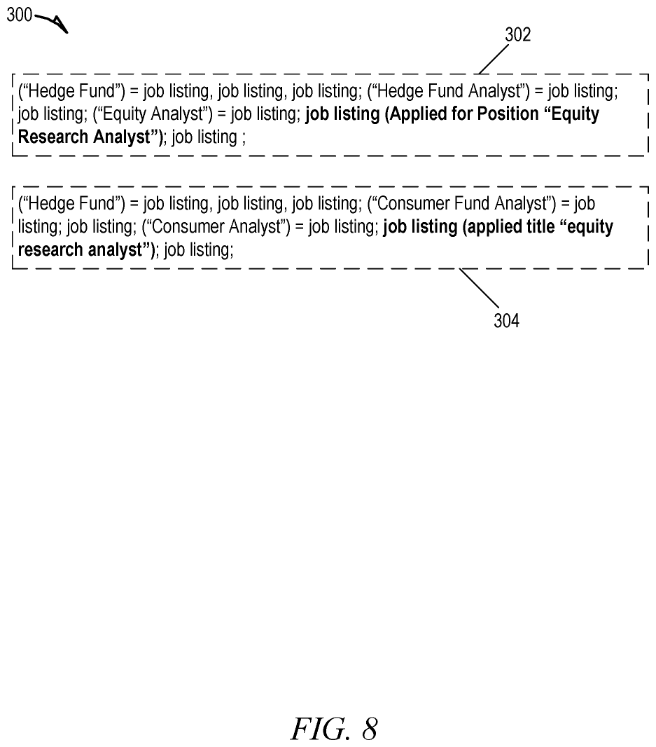

FIG. 8 shows activity data generated by a search system 104, accordingly to some example embodiments. The activity data 800 shown in FIG. 8 is generated by the search system 104 as a result of a user interacting with the search system 104 to search for job listings. As shown, the activity data 800 includes two data records 802, 804, each of which represents a separate activity session associated with the user. For example, the first data record 802 includes activity data describing a first activity session of the user, and the second data record 804 includes activity data describing a second activity session of the user. Although only two data records 802, 804 are shown, this is just for ease of explanation and is not meant to be limiting. The activity data 800 may include any number of data records 802, 804.

Each data record 802, 804 includes data indicating the search terms entered by the user, resulting search results (e.g., job listings), search results selected by the user (e.g., selected job listings), and search results in which the user performed an additional action (e.g., applied for a listed job). For example, as show, the first data record 802 indicates that during the first activity session, the user initially entered the search term “hedge fund,” resulting in three search results, none of which were selected by the user. The user then entered the search term “hedge fund analyst,” resulting in two search results, neither of which was selected by the user. The user then entered the search term “equity analyst” which resulted in three search results, the second of which the user selected and applied for. The first data record 802 also includes data indicating that the title of the job posting that the user applied for is “equity research analyst.”

The second data record 804 indicates that during the second activity session, the user initially entered the search term “hedge fund,” resulting in three search results, none of which were selected by the user. The user then entered the search term “consumer fund analyst,” resulting in two search results, neither of which was selected by the user. The user then entered the search term “equity analyst” which resulted in three search results, the second of which the user selected and applied for. The second data record 804 also includes data indicating that the title of the job posting that the user applied for is “equity research analyst.”

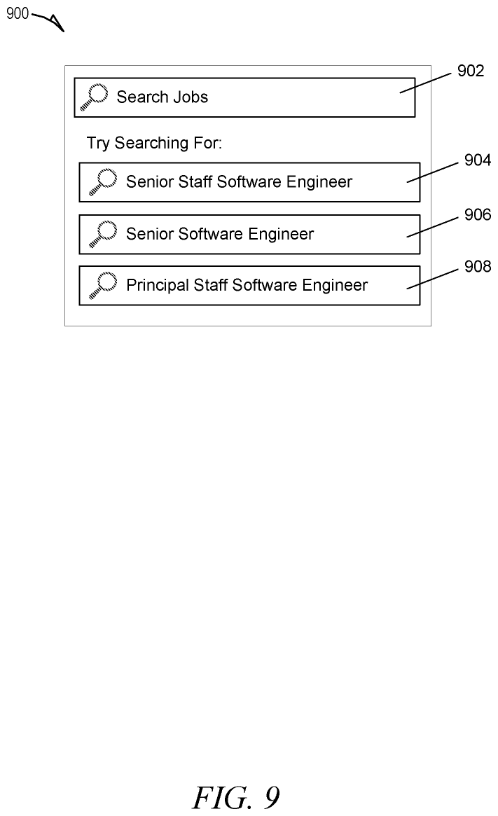

FIG. 9 is a search interface 900 including search query recommendations, according to certain example embodiments. As shown, the search interface 900 includes a search term input field 902 that enables a user to enter search terms and execute a search query. Three search query recommendations 904, 906, 908 are presented below the search term input field 902. A user may execute a search query based on the any of the search query recommendations 904, 906, 908. As shown, each search query recommendation 904, 906, 908 identifies the search terms to be used in the recommended search query. For example, the first recommended search query 904 is based on the search term “Senior Staff Software Engineer,” the second recommended search query 906 is based on the search term “Senior Software Engineer,” and the third recommended search query 908 is based on the search term “Principal Staff Software Engineer.”

A user may execute a recommended search query 904, 906, 908 by entering the corresponding search term in the search term input field 902. Alternatively, in some embodiments, the recommended search queries 904, 906, 908 may be selectable such that a user may simply select any of the recommended search queries 904, 906, 908 to cause a search query to be executed based on the corresponding search terms.

### Software Architecture

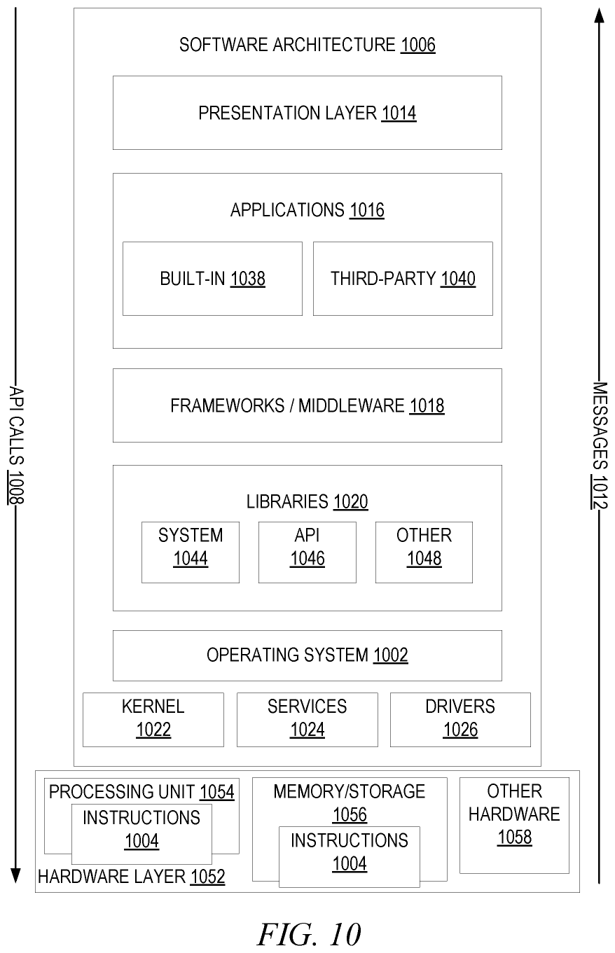

FIG. 10 is a block diagram illustrating an example software architecture 1006, which may be used in conjunction with various hardware architectures herein described. FIG. 10 is a non-limiting example of a software architecture 1006 and it will be appreciated that many other architectures may be implemented to facilitate the functionality described herein. The software architecture 1006 may execute on hardware such as machine 1100 of FIG. 11 that includes, among other things, processors 1104, memory 1114, and (input/output) I/O components 1118. A representative hardware layer 1052 is illustrated and can represent, for example, the machine 1100 of FIG. 11. The representative hardware layer 1052 includes a processing unit 1054 having associated executable instructions 1004. Executable instructions 1004 represent the executable instructions of the software architecture 1006, including implementation of the methods, components, and so forth described herein. The hardware layer 1052 also includes memory and/or storage modules memory/storage 1056, which also have executable instructions 1004. The hardware layer 1052 may also comprise other hardware 1058.

In the example architecture of FIG. 10, the software architecture 1006 may be conceptualized as a stack of layers where each layer provides particular functionality. For example, the software architecture 1006 may include layers such as an operating system 1002, libraries 1020, frameworks/middleware 1018, applications 1016, and a presentation layer 1014. Operationally, the applications 1016 and/or other components within the layers may invoke API calls 1008 through the software stack and receive a response such as messages 1012 in response to the API calls 1008. The layers illustrated are representative in nature and not all software architectures have all layers. For example, some mobile or special purpose operating systems may not provide a frameworks/middleware 1018, while others may provide such a layer. Other software architectures may include additional or different layers.

The operating system 1002 may manage hardware resources and provide common services. The operating system 1002 may include, for example, a kernel 1022, services 1024, and drivers 1026. The kernel 1022 may act as an abstraction layer between the hardware and the other software layers. For example, the kernel 1022 may be responsible for memory management, processor management (e.g., scheduling), component management, networking, security settings, and so on. The services 1024 may provide other common services for the other software layers. The drivers 1026 are responsible for controlling or interfacing with the underlying hardware. For instance, the drivers 1026 include display drivers, camera drivers, Bluetooth® drivers, flash memory drivers, serial communication drivers (e.g., Universal Serial Bus (USB) drivers), Wi-Fi® drivers, audio drivers, power management drivers, and so forth, depending on the hardware configuration.

The libraries 1020 provide a common infrastructure that is used by the applications 1016 and/or other components and/or layers. The libraries 1020 provide functionality that allows other software components to perform tasks in an easier fashion than to interface directly with the underlying operating system 1002 functionality (e.g., kernel 1022, services 1024 and/or drivers 1026). The libraries 1020 may include system libraries 1044 (e.g., C standard library) that may provide functions such as memory allocation functions, string manipulation functions, mathematical functions, and the like. In addition, the libraries 1020 may include API libraries 1046 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 1020 may also include a wide variety of other libraries 1048 to provide many other APIs to the applications 1016 and other software components/modules.

The frameworks/middleware 1018 (also sometimes referred to as middleware) provide a higher-level common infrastructure that may be used by the applications 1016 and/or other software components/modules. For example, the frameworks/middleware 1018 may provide various graphic user interface (GUI) functions, high-level resource management, high-level location services, and so forth. The frameworks/middleware 1018 may provide a broad spectrum of other APIs that may be used by the applications 1016 and/or other software components/modules, some of which may be specific to a particular operating system 1002 or platform.

The applications 1016 include built-in applications 1038 and/or third-party applications 1040. Examples of representative built-in applications 1038 may include, but are not limited to, a contacts application, a browser application, a book reader application, a location application, a media application, a messaging application, and/or a game application. Third-party applications 1040 may include an application developed using the ANDROID™ or IOS™ software development kit (SDK) by an entity other than the vendor of the particular platform, and may be mobile software running on a mobile operating system such as IOS™ ANDROID™, WINDOWS® Phone, or other mobile operating systems. The third-party applications 1040 may invoke the API calls 1008 provided by the mobile operating system (such as operating system 1002) to facilitate functionality described herein.

The applications 1016 may use built in operating system functions (e.g., kernel 1022, services 1024 and/or drivers 1026), libraries 1020, and frameworks/middleware 1018 to create user interfaces to interact with users of the system. Alternatively, or additionally, in some systems, interactions with a user may occur through a presentation layer, such as presentation layer 1014. In these systems, the application/component “logic” can be separated from the aspects of the application/component that interact with a user.

FIG. 11 is a block diagram illustrating components of a machine 1100, according to some example embodiments, able to read instructions 1004 from a machine-readable medium (e.g., a machine-readable storage medium) and perform any one or more of the methodologies discussed herein. Specifically, FIG. 11 shows a diagrammatic representation of the machine 1100 in the example form of a computer system, within which instructions 1110 (e.g., software, a program, an application, an applet, an app, or other executable code) for causing the machine 1100 to perform any one or more of the methodologies discussed herein may be executed. As such, the instructions 1110 may be used to implement modules or components described herein. The instructions 1110 transform the general, non-programmed machine 1100 into a particular machine 1100 programmed to carry out the described and illustrated functions in the manner described. In alternative embodiments, the machine 1100 operates as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine 1100 capable of executing the instructions 1110, sequentially or otherwise, that specify actions to be taken by machine 1100. Further, while only a single machine 1100 is illustrated, the term “machine” shall also be taken to include a collection of machines that individually or jointly execute the instructions 1110 to perform any one or more of the methodologies discussed herein.

The machine 1100 may include processors 1104, memory/storage 1106, and I/O components 1118, which may be configured to communicate with each other such as via a bus 1102. The memory/storage 1106 may include a memory 1114, such as a main memory, or other memory storage, and a storage unit 1116, both accessible to the processors 1104 such as via the bus 1102. The storage unit 1116 and memory 1114 store the instructions 1110 embodying any one or more of the methodologies or functions described herein. The instructions 1110 may also reside, completely or partially, within the memory 1114, within the storage unit 1116, within at least one of the processors 1104 (e.g., within the processor's cache memory), or any suitable combination thereof, during execution thereof by the machine 1100. Accordingly, the memory 1114, the storage unit 1116, and the memory of processors 1104 are examples of machine-readable media.

The I/O components 1118 may include a wide variety of components to receive input, provide output, produce output, transmit information, exchange information, capture measurements, and so on. The specific I/O components 1118 that are included in a particular machine 1100 will depend on the type of machine. For example, portable machines such as mobile phones will likely include a touch input device or other such input mechanisms, while a headless server machine will likely not include such a touch input device. It will be appreciated that the I/O components 1118 may include many other components that are not shown in FIG. 11. The I/O components 1118 are grouped according to functionality merely for simplifying the following discussion and the grouping is in no way limiting. In various example embodiments, the I/O components 1118 may include output components 1126 and input components 1128. The output components 1126 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1128 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1118 may include biometric components 1130, motion components 1134, environmental components 1136, or position components 1138 among a wide array of other components. For example, the biometric components 1130 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1134 may include acceleration sensor components (e.g., accelerometer), gravitation sensor components, rotation sensor components (e.g., gyroscope), and so forth. The environmental components 1136 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1138 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1118 may include communication components 1140 operable to couple the machine 1100 to a network 1132 or devices 1120 via coupling 1124 and coupling 1122, respectively. For example, the communication components 1140 may include a network interface component or other suitable device to interface with the network 1132. In further examples, communication components 1140 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 1120 may be another machine or any of a wide variety of peripheral devices (e.g., a peripheral device coupled via a USB).

Moreover, the communication components 1140 may detect identifiers or include components operable to detect identifiers. For example, the communication components 1140 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1140, such as, location via Internet Protocol (IP) geo-location, location via Wi-Fi® signal triangulation, location via detecting a NFC beacon signal that may indicate a particular location, and so forth.

### Glossary

“CARRIER SIGNAL” in this context refers to any intangible medium that is capable of storing, encoding, or carrying instructions 1110 for execution by the machine 1100, and includes digital or analog communications signals or other intangible medium to facilitate communication of such instructions 1110. Instructions 1110 may be transmitted or received over the network 1132 using a transmission medium via a network interface device and using any one of a number of well-known transfer protocols.

“CLIENT DEVICE” in this context refers to any machine 1100 that interfaces to a communications network 1132 to obtain resources from one or more server systems or other client devices. A client device may be, but is not limited to, a mobile phone, desktop computer, laptop, PDAs, smart phones, tablets, ultra books, netbooks, laptops, multi-processor systems, microprocessor-based or programmable consumer electronics, game consoles, STBs, or any other communication device that a user may use to access a network 1132.

“COMMUNICATIONS NETWORK” in this context refers to one or more portions of a network 1132 that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network 1132 or a portion of a network 1132 may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions 1110 and data temporarily or permanently and may include, but is not be limited to, random-access memory (RAM), read-only memory (ROM), buffer memory, flash memory, optical media, magnetic media, cache memory, other types of storage (e.g., erasable programmable read-only memory (EEPROM)), and/or any suitable combination thereof. The term “machine-readable medium” should be taken to include a single medium or multiple media (e.g., a centralized or distributed database, or associated caches and servers) able to store instructions 1110. The term “machine-readable medium” shall also be taken to include any medium, or combination of multiple media, that is capable of storing instructions 1110 (e.g., code) for execution by a machine 1100, such that the instructions 1110, when executed by one or more processors 1104 of the machine 1100, cause the machine 1100 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors 1104) may be configured by software (e.g., an application 1016 or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor 1104 or other programmable processor 1104. Once configured by such software, hardware components become specific machines 1100 (or specific components of a machine 1100) uniquely tailored to perform the configured functions and are no longer general-purpose processors 1104. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor 1104 configured by software to become a special-purpose processor, the general-purpose processor 1104 may be configured as respectively different special-purpose processors (e.g., comprising different hardware components) at different times. Software accordingly configures a particular processor or processors 1104, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses 1102) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors 1104 that are temporarily configured (e.g., by software) or permanently configured to perform the relevant operations. Whether temporarily or permanently configured, such processors 1104 may constitute processor-implemented components that operate to perform one or more operations or functions described herein. As used herein, “processor-implemented component” refers to a hardware component implemented using one or more processors 1104. Similarly, the methods described herein may be at least partially processor-implemented, with a particular processor or processors 1104 being an example of hardware. For example, at least some of the operations of a method may be performed by one or more processors 1104 or processor-implemented components. Moreover, the one or more processors 1104 may also operate to support performance of the relevant operations in a “cloud computing” environment or as a “software as a service” (SaaS). For example, at least some of the operations may be performed by a group of computers (as examples of machines 1100 including processors 1104), with these operations being accessible via a network 1132 (e.g., the Internet) and via one or more appropriate interfaces (e.g., an API). The performance of certain of the operations may be distributed among the processors 1104, not only residing within a single machine 1100, but deployed across a number of machines 1100. In some example embodiments, the processors 1104 or processor-implemented components may be located in a single geographic location (e.g., within a home environment, an office environment, or a server farm). In other example embodiments, the processors 1104 or processor-implemented components may be distributed across a number of geographic locations.

“PROCESSOR” in this context refers to any circuit or virtual circuit (a physical circuit emulated by logic executing on an actual processor) that manipulates data values according to control signals (e.g., “commands,” “op codes,” “machine code,” etc.) and which produces corresponding output signals that are applied to operate a machine 1100. A processor 1104 may be, for example, a central processing unit (CPU), a reduced instruction set computing (RISC) processor, a complex instruction set computing (CISC) processor, a graphics processing unit (GPU), a digital signal processor (DSP), an ASIC, a radio-frequency integrated circuit (RFIC) or any combination thereof. A processor may further be a multi-core processor having two or more independent processors 1104 (sometimes referred to as “cores”) that may execute instructions 1110 contemporaneously.

What is claimed is:

1. A method comprising:
generating a first multi-session embedding vector representing a first search-query session and a second search-query session associated with a first user, the first multi-session embedding vector generated based on a first activity data set corresponding to the first search-query session and a second activity data set corresponding to the second activity session, the first activity data set including data describing usage of a search query system by the first user during a first time period and the second activity data set including data describing usage of the search query system by the first user during a second time period;
generating a first set of probability values for a set of candidate search terms based on the first multi-session embedding vector, the first set of probability values generated by providing the first multi-session embedding vector as input into a text classification model trained based on multi-session embedding vectors generated from historical activity data;
generating a recommended search query from the set of candidate search terms based on the first set of probability values; and
causing presentation of the recommended search query within a user interface presented on a display of a client device.

2. The method of claim 1, wherein generating the first multi-session embedding vector comprises:
generating, based on the first activity data set, a first single-session embedding vector representing the first search-query session;
generating, based on the second activity data set, a second single-session embedding vector representing the second search-query session; and
generating the first multi-session embedding vector based on the first single-session embedding vector and the second single-session embedding vector.

3. The method of claim 2, wherein generating the first single-session embedding vector comprises:
generating a first token embedding vector representing a first token from the first activity data set;
generating a second token embedding vector representing a second token from the first activity data set; and
generating the first single-session embedding vector based on the first token embedding vector and the second token embedding vector.

4. The method of claim 3, wherein the first token embedding vector is generated by providing the first token as input into a word embedding encoder and the second token embedding vector is generated by providing the second token as input into the word embedding encoder.

5. The method of claim 3, wherein generating the first single-session embedding vector based on the first token embedding vector and the second token embedding vector comprises:
determining an average of at least the first token embedding vector and the second token embedding vector.

6. The method of claim 1, further comprising:
generating a search query sequence for the first user, the search query sequence including at least a first search query and a second search query executed by the first user, the at least the first search query and the second search query being ordered sequentially in the search query sequence based on a real-time order in which each respective search query was executed; and
generating a second recommended search query for the first user based on the search query sequence, the second recommended search query generated by providing the search query sequence as input into a sequence to sequence model trained based on a set of training search query sequences generated from the historical activity data; and
causing presentation of the second recommended search query within the user interface presented on the display of the client device.

7. The method of claim 6, wherein the first search query was executed by the first user during the first search-query session and the second search query was executed by the first user during the second activity session.

8. A system comprising:
one or more computer processors; and
one or more computer-readable mediums storing instructions that, when executed by the one or more computer processors, cause the system to perform operations comprising:
generating a first multi-session embedding vector representing a first search-query session and a second search-query session associated with a first user, the first multi-session embedding vector generated based on a first activity data set corresponding to the first search-query session and a second activity data set corresponding to the second activity session, the first activity data set including data describing usage of a search query system by the first user during a first time period and the second activity data set including data describing usage of the search query system by the first user during a second time period;
generating a first set of probability values for a set of candidate search terms based on the first multi-session embedding vector, the first set of probability values generated by providing the first multi-session embedding vector as input into a text classification model trained based on multi-session embedding vectors generated from historical activity data;
generating a recommended search query from the set of candidate search terms based on the first set of probability values; and
causing presentation of the recommended search query within a user interface presented on a display of a client device.

9. The system of claim 8, wherein generating the first multi-session embedding vector comprises:
generating, based on the first activity data set, a first single-session embedding vector representing the first search-query session;
generating, based on the second activity data set, a second single-session embedding vector representing the second search-query session; and
generating the first multi-session embedding vector based on the first single-session embedding vector and the second single-session embedding vector.

10. The system of claim 9, wherein generating the first single-session embedding vector comprises:
generating a first token embedding vector representing a first token from the first activity data set;
generating a second token embedding vector representing a second token from the first activity data set; and
generating the first single-session embedding vector based on the first token embedding vector and the second token embedding vector.

11. The system of claim 10, wherein the first token embedding vector is generated by providing the first token as input into a word embedding encoder and the second token embedding vector is generated by providing the second token as input into the word embedding encoder.

12. The system of claim 10, wherein generating the first single-session embedding vector based on the first token embedding vector and the second token embedding vector comprises:
determining an average of at least the first token embedding vector and the second token embedding vector.

13. The system of claim 8, the operations further comprising:
generating a search query sequence for the first user, the search query sequence including at least a first search query and a second search query executed by the first user, the at least the first search query and the second search query being ordered sequentially in the search query sequence based on a real-time order in which each respective search query was executed; and
generating a second recommended search query for the first user based on the search query sequence, the second recommended search query generated by providing the search query sequence as input into a sequence to sequence model trained based on a set of training search query sequences generated from the historical activity data; and
causing presentation of the second recommended search query within the user interface presented on the display of the client device.

14. The system of claim 13, wherein the first search query was executed by the first user during the first search-query session and the second search query was executed by the first user during the second activity session.

15. A non-transitory computer-readable medium storing instructions that, when executed by one or more computer processors of one or more computing devices, cause the one or more computing devices to perform operations comprising:
generating a first multi-session embedding vector representing a first search-query session and a second search-query session associated with a first user, the first multi-session embedding vector generated based on a first activity data set corresponding to the first search-query session and a second activity data set corresponding to the second activity session, the first activity data set including data describing usage of a search query system by the first user during a first time period and the second activity data set including data describing usage of the search query system by the first user during a second time period;
generating a first set of probability values for a set of candidate search terms based on the first multi-session embedding vector, the first set of probability values generated by providing the first multi-session embedding vector as input into a text classification model trained based on multi-session embedding vectors generated from historical activity data;
generating a recommended search query from the set of candidate search terms based on the first set of probability values; and
causing presentation of the recommended search query within a user interface presented on a display of a client device.

16. The non-transitory computer-readable medium of claim 15, wherein generating the first multi-session embedding vector comprises:
generating, based on the first activity data set, a first single-session embedding vector representing the first search-query session;
generating, based on the second activity data set, a second single-session embedding vector representing the second search-query session; and
generating the first multi-session embedding vector based on the first single-session embedding vector and the second single-session embedding vector.

17. The non-transitory computer-readable medium of claim 16, wherein generating the first single-session embedding vector comprises:
generating a first token embedding vector representing a first token from the first activity data set;
generating a second token embedding vector representing a second token from the first activity data set; and
generating the first single-session embedding vector based on the first token embedding vector and the second token embedding vector.

18. The non-transitory computer-readable medium of claim 17, wherein the first token embedding vector is generated by providing the first token as input into a word embedding encoder and the second token embedding vector is generated by providing the second token as input into the word embedding encoder.

19. The non-transitory computer-readable medium of claim 17, wherein generating the first single-session embedding vector based on the first token embedding vector and the second token embedding vector comprises:
determining an average of at least the first token embedding vector and the second token embedding vector.

20. The non-transitory computer-readable medium of claim 15, the operations further comprising:
generating a search query sequence for the first user, the search query sequence including at least a first search query and a second search query executed by the first user, the at least the first search query and the second search query being ordered sequentially in the search query sequence based on a real-time order in which each respective search query was executed; and
generating a second recommended search query for the first user based on the search query sequence, the second recommended search query generated by providing the search query sequence as input into a sequence to sequence model trained based on a set of training search query sequences generated from the historical activity data; and
causing presentation of the second recommended search query within the user interface presented on the display of the client device.
